(19) United States
(12) Patent Application Publication
(10) Pub. No.: US 2004/0143446 A1
(43) Pub. Date: Jul. 22, 2004

(54) Long term care risk management clearinghouse

(76) Inventor: David Lawrence, New York, NY (US)

Correspondence Address: Joseph P. Kincart, Esq., Clifford Chance US LLP, 200 Park Avenue, New York, NY, 10016, US

(21) Appl. No.: 10/625,049

(22) Filed: Jul. 22, 2003

Related U.S. Application Data
(63) Continuation-in-part of application No. 10/074,584, filed on Feb. 12, 2002.
(63) Continuation-in-part of application No. 10/021,124, filed on Oct. 30, 2001.
Application No. 10/021,124 is a continuation-in-part of application No. 09/812,627, filed on Mar. 20, 2001.
(60) Provisional application No. 60/397,810, filed on Jul. 22, 2002.

(51) Int. Cl. G06F 17/60

(52) U.S. Cl. 705/1

(57) ABSTRACT

Systems, methods, apparatus, computer program code and means for gathering, organizing and presenting on a real time basis information pertinent to Risks associated with long term care related subjects. Risks associated with long term care can be managed by gathering data relevant to long term care from multiple sources and aggregating the gathered data according to one or more risk variables. An inquiry relating to a risk subject can be received and portions of the aggregated data can be associated with the risk subject. The associated portions of the aggregated data can be transmitted to an entity placing the inquiry or other designated destination.

### CROSS REFERENCE TO RELATED APPLICATIONS

This application claims the benefit of the filing date of U.S. Provisional application No. 60/390,459 entitled “Propriety Risk Management”, filed Jun. 20, 2002. This application also claims the benefit of the filing date of U.S. Provisional application No. 60/397,810 entitled “Long Term Care Risk Management Clearinghouse”, filed Jul. 22, 2002. This application is a continuation-in-part of a prior application entitled “Risk Management Clearinghouse” filed Feb. 12, 2002 and bearing the Ser. No. 10/074,584, as well as being a continuation-in-part of a prior application entitled “Risk Management Clearinghouse” filed Oct. 30, 2001, and bearing the Ser. No. 10/021,124, which is also a continuation-in-part of a prior application entitled “Automated Global Risk Management” filed Mar. 20, 2001, and bearing the Ser. No. 09/812,627, all of which are relied upon and incorporated by reference.

### FIELD

The present invention relates to systems, methods, apparatus, computer program code and means for facilitating the identification, investigation, assessment and management of legal, regulatory, financial and reputational risks (“Risks”). More particularly, embodiments of the present invention relate to systems, methods, apparatus, computer program code and means to conduct due diligence and research and make informed decisions to manage Risks related to Long Tern Care (LTC).

### BACKGROUND

Demand for nursing home care or other LTC due to old age, frailty, injury, chronic illness or other cause has steadily increased during the current generation due to many factors including the aging population and the unavailability of family provided care resulting from the increase of women partaking in the workforce. There are some indications that over 40% of the population over the age of 65 will require LTC. This demand has resulted in a significant increase in resources dedicated to the LTC industry and also a significant increase in the number of people who must make decisions related to LTC. For example, decisions can relate to the physical, mental and fiduciary well being of a LTC recipient or to an investment in the LTC industry.

Issues relating to physical, mental and fiduciary well being of a LTC recipient can be multi-faceted and difficult to quantify. In some respects, quality of a LTC organization can be a subjective qualification and in other respects it can be an objective quantification. Information which can be utilized to rate a LTC organization can be scattered in disparate places.

Government agencies have conducted surveys, or other inspections of LTC facilities, in an attempt to regulate the industry and assure a minimum standard of care. Often, such inspections will be linked to government funding, such as Medicare or Medicaid qualification. Some content or results of such surveys can be available to the pubic if the public is savvy enough to locate the content. Other sources of pertinent information can include court records, public records, employee backgrounds, financial statements and other due diligence material.

Currently there is no convenient way to facilitate a comprehensive analysis of an LTC or an LTC provider without strenuous research of multiple disparate sources. What is needed is a tool to facilitate analysis of LTC related subjects.

### SUMMARY

Accordingly, to alleviate problems inherent in the prior art and facilitate analysis of LTC related subjects, embodiments of the present invention introduce systems, methods, apparatus, computer program code and means for gathering, organizing and presenting on a real time basis information pertinent to Risks associated with LTC related subjects. According to some embodiments, Risks associated with LTC can be managed by gathering data relevant to long term care from multiple sources and aggregating the gathered data according to one or more risk variables. An inquiry relating to a risk subject can be received and portions of the aggregated data can be associated with the risk subject. The associated portions of the aggregated data can be transmitted to an entity placing the inquiry or other designated destination.

Systems, methods, apparatus, computer program code and means for managing Risks are also provided where an alert can be implemented to continually monitor data and transmit any updated data associated with the risk subject.

Systems, methods, apparatus, computer program code and means for managing Risks can be implemented by interacting with a network access device to access a risk management server. Interaction can be initiated via a communications network and information descriptive of a risk subject related to LTC can be input and transmitted to a risk management clearinghouse server. The server can respond by transmitting data associated with risk variables that relate to the risk subject which can be received at the network access device.

With these and other advantages and features of the invention that will become hereinafter apparent, the invention may be more clearly understood by reference to the following detailed description of the invention, the appended claims, and the drawings attached herein.

### BRIEF DESCRIPTION OF THE DRAWINGS

FIG. 1 illustrates a block diagram that can embody this invention;

FIG. 2 illustrates a network of computer systems that can embody an automated RMC risk management system;

FIG. 3 illustrates a flow of exemplary steps that can be executed by a system implementing the present invention;

FIG. 4 illustrates a flow of exemplary steps that can be executed by a system to implement augmented data;

FIG. 5 illustrates a flow of exemplary steps that can taken by a user of the RMC risk management system; and

FIG. 6 is a table illustrating an exemplary data structure of a customer routing database for use in the present invention.

### DETAILED DESCRIPTION

The present invention includes computerized systems and methods for managing Risk associated with LTC or a LTC provider. A computerized system continuously gathers and stores information as data in a database or other data storing structure and processes the data in preparation for a Risk inquiry search relating to a Risk subject, such as a LTC facility, a LTC provider, a LTC employee, or other LTC related subject. Document images and sources of information can also be stored. A subscriber, such as an investor, a care giver, a government entity, a financial institution, an insurance company, or other interested party, can submit a Risk management subject for which a Risk inquiry search can be performed. A Risk assessment or Risk inquiry search can be made against the gathered data and a comprehensive list of reference documents, related sources, reports and other data related to the Risk subject can be provided.

The Risk assessment or inquiry search can include data retrieved as a result of augmented retrieval methods. Scrubbed data as well as augmented data can be transmitted from a Risk management clearinghouse (RMC) to a subscriber or to a proprietary Risk system utilized by a subscriber, such as a Risk management system maintained in-house. Risk inquiry searches can be automated and made a part of standard operating procedure for decision making processes and due diligence performed by the subscriber.

Definitions

To aid in the description of the present invention, the following definitions can apply to terms utilized throughout this document:

Financial Transaction: a Financial Transaction refers to any action that anticipates a transfer of money from a first set of one or more Transaction Participants to a second set of one or more Transaction Participants. Examples of Financial Transactions can include: investment and merchant banking, public and private financing, commodities and a securities trading, commercial and consumer lending, asset management, rating of corporations and securities, public and private equity investment, public and private fixed income investment, listing to companies on a securities exchange and bourse, employee screening, auditing of corporate or other entities, legal opinions relating to a corporate or other entity, or other business related transactions.

Informational Artifact: Informational Artifact refers to a media item that contains information that can be interpreted into a humanly ascertainable form. Examples of Informational Artifacts include: a news article, a news feed portion, a video segment, a newscast, a report, an identifiable document, an agency listing, a list, a government publication, other identifiable publication, a sound byte, a sound recording, or other media item.

Risk Bearing Institution: a Risk Bearing Institution refers to any person, entity, company, corporation or statutory “person” in the business of providing Financial transactions. As such a Risk Bearing Institution can include, for example: a securities broker, a retail bank, a commercial bank, investment and merchant bank, private equity firm, asset management company, a mutual fund company, a hedge fund firm, insurance company, a credit card issuer, retail or commercial financier, a securities exchange, a regulator, a money transfer agency, bourse, an institutional or individual investor, an auditing firm, a law firm, any institution the business of which is engaging in financial activities as described in section 4(k) of the Bank Holding Act of 1956 or other entity or institution who may be involved with a financial transaction or other business transaction or any entity subject to legal and regulatory compliance obligations with respect to money laundering, fraud, corruption, terrorism, organized crime, regulatory and suspicious activity reporting, sanctions, embargoes and other regulatory risks and associated obligations.

Risks: Risks associated with a financial transaction can include factors associated with security risk, financial risk, legal risk, regulatory risk and reputational risk. A Security Risk refers to breach of a safety measure that may result in unauthorized access to a facility; unauthorized access to data; physical harm, including threat of immediate risk of harm to a person or goods. Financial Risk refers to factors indicative of monetary costs that the Risk Bearing Institution or a Transaction Participant may be exposed to as a result of a particular Financial Transaction. Monetary costs can be related to fines, forfeitures, costs to defend an adverse position, lost revenue, or other related potential sources of expense. Regulatory Risk refers to factors that may cause the Risk Bearing Institution or Transaction Participant to be in violation of rules put forth by a government entity or regulatory agency. Reputational risk relates to harm that a Risk Bearing Institution or Transaction Participant may suffer regarding its professional standing in an industry or the public eye. A Risk Bearing Institution and Transaction Participant can suffer from being associated with a situation that may be interpreted as contrary to an image of diligence, honesty and forthrightness.

Risks may be related to the duty to disclose material information, to report and possibly prevent: fraud, money laundering, foreign corrupt practices, bribery, embargoes and sanctions. Timely access to relevant data on which to base a regulatory or reputational Risk related action can be critical to conducting business and comply with regulatory requirements such as those set forth by the Patriot Act in the United States.

Risk Management Clearinghouse (RMC): RMC refers to computerized systems and methods for managing Risks and associating information and/or informational artifacts useful for quantifying Risk with a Risk subject, as more fully described in the related patent applications: 10/074,584 entitled “Risk Management Clearinghouse” filed Feb. 12, 2002, and U.S. patent application Ser. No. 10/021,124 entitled “Risk Management Clearinghouse” filed Oct. 30, 2001.

Risk Quotient: Risk Quotient refers to a quantitative value of an amount of Risk, a Risk Quotient can be based upon a weighted algorithm applied to the Risk criteria and informational artifacts.

Risk Variable: A Risk variable can be any data that can cause a Risk level to change. LTC Risk variables may include, for example, data descriptive of issues which may be addressed by federal statute, such as: the ability to select a qualified physician or other healthcare professionals; advanced notification concerning procedures or treatments, including changes to current treatment or treatment providers; participation in changes to care and treatment or planning care and treatment; incidence of physical abuse, corporal punishment, involuntary seclusion, physical or chemical restraints imposed for purposes of discipline or convenience; privacy issues including accommodations, medical treatment, written and telephonic communications, visits, meetings of family and resident groups; confidentiality regarding medical and personal records; a right to voice complaints without fear of discrimination or reprisal; accommodation of needs of preferences; access and visitation rights, including immediate access by eligible parties; equal access to quality care regardless of a source of payment; admissions policies; transfer and discharge rights; preparation and orientation; notice of bed hold period; priority re-admissions; relocation; right to be informed; religious practices available at a LTC facility; payment obligations; survey or inspections schedules and results; treatment of personal funds; statements of resident rights; and other information which may be associated with the subject matter of federal, state or local statute. Some embodiments can include associating a related statute or regulation, such as for example, a Federal or State statute or regulation, with a portion of the gathered data.

Risk variables can also include, for exemplary purposes: financial information related to an LTC provider or facility; annual reports; government filings, personnel employed by a LTC provider or at a LTC facility; stock price and/or history; corporate bonds issued, equity offerings; bankruptcy proceedings; litigations involving a LTC provider or LTC facility; types of care available at a LTC facility; demographics of a LTC facility; business developments including mergers, acquisitions, expansion, additional services or other material developments; government or regulatory actions implemented concerning a LTC facility or provider; history of fraud or maltreatment by a LTC facility, provider or employee; felony history by a LTC facility, provider or employee; or other factors.

Transaction Participant: Transaction Participant refers to a person who will partake in a Financial transaction.

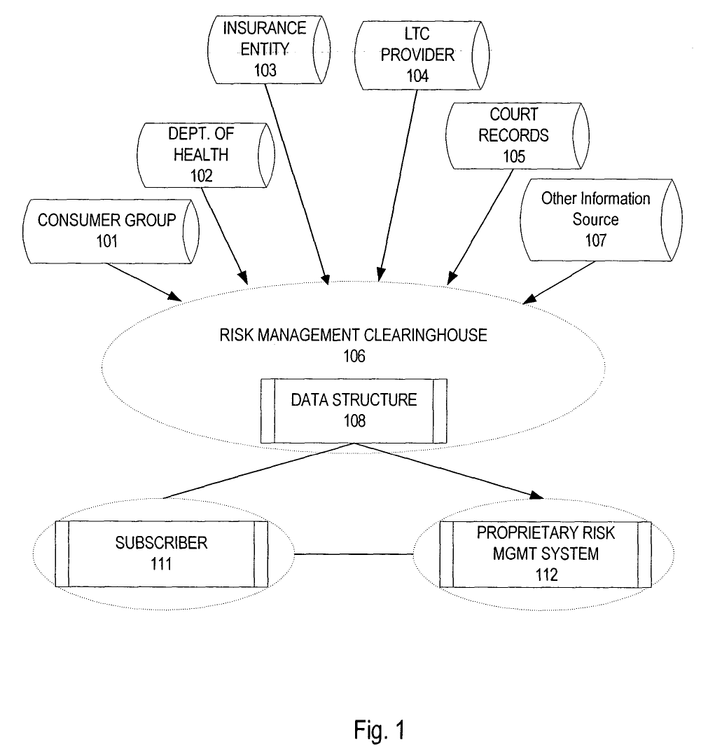

Referring now to FIG. 1 a block diagram of some embodiments of the present invention is illustrated. An RMC system 106 gathers and receives information which may be related to Risk variables associated with a LTC. Information may be received, for example, from publicly available sources 101-105, subscribers 111, investigation entities, or other sources 107. The information can be constantly updated and can be related to LTC, a LTC facility, a LTC provider, such as a parent corporation, or other LTC related subject or LTC related alert list in order to facilitate due diligence or other research efforts. The RMC system 106 facilitates due diligence on the part of a subscriber 111 by gathering, structuring and providing to the subscriber 111 data that relates to Risk variables involved in a designated LTC subject.

Risk variable related information can be received, for example, from formalized lists, such as: a list generated by a consumer watchdog group, a list generated by a state or federal agency, publications by health or LTC insurers, publications by health care advocates, publications by organizations with interested constituents, such as the American Association of Retired Person (AARP) or other source of Risk variables. Court records or other references relating to violation of regulatory statute, fraud, bankruptcy, professional reprimand or a rescission of a right to practice, suspension from professional ranks, prison records or other source of suspect behavior can also be an important source of information. Of additional interest can be information indicative that an entity is not high Risk such as participation on a major trading exchange, recommendation by a prominent insurer or advocacy group, or other endorsement.

A subscriber 111 can include, for example: a consumer or consumer group, a government agency, a securities broker, a bank, a private equity firm, an asset management company, a mutual fund company, a hedge fund firm, an insurance company, a securities exchange, an institutional or individual investor, an auditing firm, a law firm, any institution which includes in its business, investment in, advice relating to, or involvement with a LTC facility or LTC provider.

In some embodiments, information can be supplied to a RMC 106 by a subscriber 111. Information supplied by a subscriber 111 can include data gathered according to a normal course of dealings with a particular LTC related entity.

A transaction that involves a LTC entity can include a financial investment that involves an LTC facility or an LTC provider. The financial investment can include, for example: public and private financing; securities trading; commercial and consumer lending; asset management; rating of corporations and securities; public and private equity investment; public and private fixed income investment; listing of a company on a securities exchange, employee screening, auditing of corporate or other entity, legal opinions relating to a corporate or other entity, or other business related transactions.

In other embodiments, a transaction that involves a LTC can include admitting a person to a LTC facility which can affect one or more of physical, mental and fiduciary well being of an individual.

A decision involving a LTC provider or facility can be dependent upon many factors. A multitude and diversity of Risks related to the factors may need to be identified and evaluated. In addition, the weight and implications of the factors and associated Risks can be interrelated. The present invention can provide a consistent and uniform method for a consumer, business, legal, compliance, credit and other related interest to identify and assess Risks associated with a LTC provider or facility. An RMC system 106 can allow LTC related and investment activity Risks to be identified, correlated and quantified by a subscriber on a confidential or public basis and facilitate the assessment of legal, regulatory, financial and reputational exposure.

Similarly, the RMC system 106 can support a financial institution's effort to meet requirements regarding the maintenance of accurate books and records relating to their financial transactions involving a LTC entity and affirmative duty to disclose material issues affecting an investor's decisions involving a LTC facility or provider.

Information gathered from the diversity of data sources can be aggregated into a 25 searchable data storage structure 108. Some embodiments can include receiving and storing a source of information. In some instances a subscriber 111 may wish to receive information regarding the source of information received, such as, for example, if a subscriber wishes to pursue obtaining additional related information; ascertain the veracity of the information; check to see how current the information is; determine credibility of the source or other reason. Gathering data 108 into an aggregate data structure 108, such as a data warehouse can allow a RMC system 106 to have the data 108 readily available for processing a Risk management search associated with a Risk subject. Aggregated data 108 can also be scrubbed or otherwise enhanced.

In some embodiments including enhanced data, data scrubbing can be utilized to implement a data warehouse comprising the aggregate data structure 108. Data scrubbing can access information from multiple databases and store it in a manner that gives more efficient more flexible access to key facts. Scrubbing can facilitate expedient access to accurate data commensurate with a critical decision that may be based upon a Risk management assessment provided.

Various data scrubbing routines can be utilized to facilitate aggregation of Risk variable related information. The routines can include programs capable of correcting a specific type of mistake, such as an incomprehensible address, or clean up a full spectrum of commonly found database flaws, such as field alignment that can pick up misplaced data and move it to a correct field, or removing inconsistencies and inaccuracies from like data. Other scrubbing routines can be directed directly towards specific LTC issues, such as inspection results, filed complaints or court records.

A scrubbing routine can be useful, for example, to facilitate coordination of related terms utilized in different jurisdictions, such as State agencies responsible for inspections required to comply with Federal funding (Medicaid, Medicare and the like). Disparate States may term such inspections surveys, on site visits, reviews or other phrase. A data scrubbing routine can be programmed to facilitate Risk variable searching for multiple spellings of an equivalent term or other important information. Such a routine can enhance the value of the aggregate data gathered and also help correct database flaws. Scrubbing routines can improve and expand data quality more efficiently than manual mending and also allow a subscriber 111 to quantify best practices for regulatory or other purposes.

Retrieving information related to Risk variables from the aggregated data 108 is an operation with the goal to fulfill a given a request. In order to process a request against a large document set of aggregated Risk data with a response time acceptable to the user, it may be necessary to utilize an index based approach to facilitate acceptable response times. A direct string comparison based search may be unsuitable for the task.

An index file for a collection of documents can therefore be built upon receipt of new data and prior to a query or other request. The index file can include a pointer to the document and also include important information contained in the documents the index points to. At query time, the RMC system 106 can match the query against a representation of the documents, instead of the documents themselves. The RMC system 106 can retrieve the documents referenced by the indexes in order to satisfy a request submitted by a subscriber 111. However, it may not be necessary to retrieve the full document as index records may also contain the relevant information gleaned from the documents they point to. This allows a subscriber 111 to obtain information of interest without having to read a related source document.

For example, at least two retrieval models can be utilized in fulfilling a search request: a) Boolean, in which the document set is partitioned in two disjoint parts: one fulfilling the query and one not fulfilling it, and b) relevance ranking based in which all the documents are considered relevant to a certain degree. Boolean logic models can use exact matching, while relevance ranking models typically utilize fuzzy logic, vector space techniques, neural networks, and probabilistic schema.

Augmenting data can include data mining techniques which utilize software to analyze and sift through aggregated data 108 using techniques such as mathematical modeling, statistical analysis, pattern recognition, rule based trends or other data analysis tools. In contrast to a system that may have gathered and stored information in a flat file and regurgitated the stored information when requested, such as in a defined report related to a specific Risk subject or other ad hoc access concerned with a particular query at hand, the present invention can provide Risk related searching that adds a discovery dimension by returning results that human operator would find very labor and cognitively intense.

This discovery dimension supplied by the RMC system 106 can be accomplished through the execution of augmenting techniques, such as data mining, applied to the Risk related data that has been aggregated. Data mining can include the extraction of implicit, previously unknown and potentially useful information from the aggregated data. This type of extraction can include unlooked for correlations, patterns or trends. Other techniques that can be applied can include fuzzy logic and/or inductive reasoning tools.

Embodiments can include a subscriber 111 accessing the RMC system 106 via a computerized system as discussed more fully below. The subscriber 111 can input a description of a Risk subject, or other inquiry, such as, for example, the name of a party involved with a LTC facility. In some instances, and in accordance with applicable laws, identifying information relating to our individual can also be input, such as a date of birth, a place of birth, a social security number or other identifying number, or any other descriptive information. The RMC system 106 can receive any input information descriptive of the risk subject and perform a Risk related inquiry or search related to the risk subject on the scrubbed data.

A log or other stored history can be created by the RMC system 106 and/or a PRM system 112, such that utilization of the system can mitigate adverse effects relating to a problematic situation. Mitigation can be accomplished by demonstrating to an investor or other interested party that due diligence is being addressed through tangible Risk management processes.

Questions can also be presented to an inquiry initiator by a programmable robot via a graphical user interface (GUI). Questions can relate to a particular LTC provider or a LTC facility, a particular type of client, types of investment, or other criteria or subject.

A query may, for example, search for information relating to a Risk subject, such as an individual or circumstance associated with LTC and provide questions, historical data, world event information and other targeted information to facilitate a determination of Risk associated with a Risk subject. For example, a query regarding a Risk entity's financial position can be input and include reference to a LTC facility, a LTC provider, a parent organization, or other related detail. Measures can also be put in place to insure that all such inquiries should be subject to prevailing law and contractual obligations.

A query can include direct input into a RMC system 106, such as through a GUI with input areas or prompts. A query can also be automatically generated from monitoring transactions, investments, recommendations or other actions undertaken by a subscriber 111. For example, an information system can electronically scan communication data for key words, entity names, treatment types or other pertinent data. Programmable software can be utilized to formulate a query according to names, treatment descriptions, investments or other pertinent data and run the query against a database maintained by the RMC system 106. Other methods can include voice queries via a telephone or other voice line, such as voice over internet, fax, electronic messaging, or other means of communication.

Prompts or other questions proffered by the RMC system 106 can also depend from previous information received. Information generally received, or received in response to the questions, can be input into the RMC system 106 from which it can be utilized for real time Risk assessment and generation of a Risk valuation, such as a Risk quotient.

Some embodiments can also include an alert list containing names and/or terms of interest to a subscriber 111 which are be supplied to a RMC system 106 by a subscriber 111 or other source 107. An alert list can be customized and specific to a subscriber 111. The RMC system 106 can continually or periodically monitor data in the RMC database 108 via an alert query with key word, fuzzy logic or other search algorithm and transmit related informational data to the interested party. In this manner, ongoing diligence can be conducted. In the event that new information is uncovered by the alert query, the subscriber 111 can be immediately notified, or notified according to a predetermined schedule. Appropriate action can be taken according to the information uncovered.

In some embodiments, the RMC database can contain only information collected from publicly-available sources relevant to the provision or regulation of LTC or to LTC as an industry. A subscriber 111 can use the RMC database 108 to identify the possibility that a LTC facility is providing inappropriate, inadequate or even substandard care. In addition, an RMC 106 can be useful in determining whether a LTC provider is fiscally viable.

A subscriber 111 to the RMC system 106 can access the database 108 electronically and receive relevant information electronically or in hard copy format. A subscriber 111 can be permitted to access information in the RMC system 106 in various ways, including, for example: system to system inquires involving single or batch screening requests, individual inquiries (submitted electronically, by facsimile, or by phone), or through a web-based interface supporting various query types.

In some embodiments, an RMC system 106 can take any necessary steps so as not to be regulated as a consumer reporting agency. Such steps may include not collecting or permitting others to use information from the RMC database 108 to establish an individual's eligibility for consumer credit or insurance, other business transactions, or for employment or other Fair Credit Reporting Act (FCRA) covered purposes such as eligibility for a government benefit or license.

To satisfy the requirements of such embodiments, a subscription agreement can be established between the RMC system 106 provider and a subscriber 111 which will create enforceable contractual provisions prohibiting the use of data from the RMC database 108 for such purposes. The operations of the RMC system 106 can be structured to minimize the Risk that the RMC database 108 will be used to furnish consumer reports and therefore become subject to the FCRA.

Some embodiments can also include additional policies and practices which are established to achieve the objective of not being subject to FCRA, such as, for example: the information in the RMC database 108 can be collected only from reputable, publicly available sources and not contain information from consumer reports; the RMC system 106 can forego collection of or permit others to use, information from the RMC database 108 to establish an individual's eligibility for consumer credit or insurance, other business transactions, or for employment or other FCRA-covered purposes. Subscribers 111 can be required to execute a licensing agreement that will limit their use of the data to specified purposes. A subscriber 111 can be required to certify that the subscriber 111 will use the data only for such specified purposes, and to certify annually that the subscriber 111 remains in compliance with these principles.

A licensing agreement can also require that subscribers 111 separately secure information from non-RMC system 106 sources to satisfy any need the subscriber 111 has for information to be used in connection with the subscriber's determination regarding a consumer's eligibility for credit, insurance, other business transactions, or employment or for other FCRA-covered purposes.

Embodiments can also include utilization of a computerized Proprietary Risk management (PRM) system 112 that allows data gathering, data storage, data analysis, risk inquiries and other data to be maintained in a confidential manner. The PRM system 112 can receive an electronic feed from an RMC system 106 with updated raw data, scrubbed data or other data embodiment. In addition, data mining results can also be transmitted to the PRM system 112 or performed by the PRM system 112 for integration into the Risk management practices provided in-house by the subscriber 111.

Information entered by a subscriber 111 into a PRM system 112 may be information gathered according to a normal course of dealings with a particular entity or as a result of a concerted investigation. In addition, since the PRM system 112 is proprietary, and a subscriber 111 responsible for the information contained therein can control access to the information contained therein, the PRM system 112 can include information that is public or proprietary.

In addition, some embodiments can include information entered into a PRM system 112 which can be shared with a RMC system 106. Informational data can be shared, for example via an electronic transmission or transfer of electronic media. However, RMC system 106 data may be subject to applicable local or national law and safeguards should be adhered to in order to avoid violation of such law through data sharing practices. In the event that a subscriber 111, or other interested party, discovers or suspects that a person or entity is involved in a fraudulent or otherwise illegal activity, the system can also be utilized to generate a report containing related information which can be distributed to an appropriate authority.

In some embodiments, a RMC system 106 can be structured to take advantage of the immunity from liability for libel and slander granted by the Communications Decency Act (“CDA”) to providers of interactive computer services. Where its operations are not protected by the CDA, an RMC system 106 may be able to reduce its Risk of liability for defamation substantially by relying only on official sources and other reputable sources, and taking particular care with defamatory information from unofficial sources. In addition the RMC system 106 provider can take reasonable steps to assure itself of the information's accuracy, including insuring that the source of the information is reputable.

In some embodiments, a RMC system 106 can operate as an interactive computer service as that term is defined in the CDA. In such embodiments, the clearinghouse can provide an information service and/or access software that enables computer access by multiple users to a computer server. In some embodiments, if desired, an RMC system 106 provider can limit its employees or agents from creating or developing any of the content in the RMC database 108. Content be maintained unchanged except that the RMC system 106 can remove information from the RMC database 108 that it determines to be inaccurate or irrelevant.

Some embodiments can also include a value rating, such as a risk quotient which can be generated to readily indicate a level of risk associated with a particular risk subject. The risk quotient can be based upon a weighted algorithm applied to the risk variables or other factors. The risk quotient can be made available on a periodic basis, on demand in real time, in response to an event such as an inquiry a placement or an investment; or according to some other request. Actions commensurate with a risk level can be presented to assist with proper risk management.

If desired, embodiments can include a comparison of risk related data and risk quotients for disparate entities. The comparison can include data and sources of the data as well as a risk quotient value rating of an amount of risk that can be associated with each risk subject. Risk can be mitigated by the association of a risk subject with risk variables that contain less inherent risk, such as a public organization subject to reporting requirements, or a facility associated with a LTC provider that enjoys an excellent reputation.

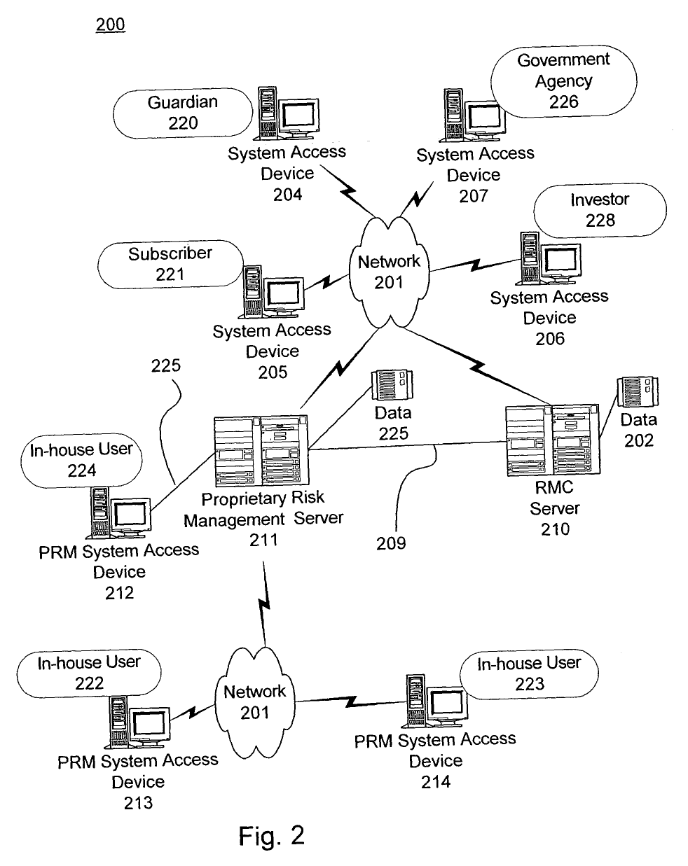

Referring now to FIG. 2, a network diagram illustrating some embodiments of the present invention is shown 200. An automated RMC 106 can include a computerized RMC server 210 accessible via a distributed network 201 such as the Internet, or a private network. A subscriber 221, guardian 220, government agency 226, investor 228, or other party interested in Risk management, can use a computerized system or network access device 204-207 to receive, input, transmit or view information processed in the RMC server 210. A protocol, such as the transmission control protocol internet protocol (TCP/IP) can be utilized to provide consistency and reliability.

In addition, a PRM server 211 can access a RMC server 210 via the network 201 or via a direct link 209, such as a T1 line or other high speed pipe. The PRM server 211 can be accessed by an in-house user 222-224 via a system access device 212-214 and a distributed network 201, such as a local area network, or other private network, or even the Internet, if desired. An in-house user 224 can also be situated to access the RMC server 210 via a direct link 225, or any other system architecture conducive to a particular need or situation.

A computerized system or system access device 204-207 212-214 used to access the RMC server 210 or the PRM server 211 can include a processor, memory and a user input device, such as a keyboard, mouse, touch screen or other device and a user output device, such as a display screen and/or printer. The system access devices 204-207, 212-214 can communicate with the RMC server 210 or the PRM server 211 to access data and programs stored at the respective servers 210-211. The system access device 212-214 may interact with the server 210-211 as if the RMC Risk management system 211 were a single entity in the network 200. However, the servers 210-211 may include multiple processing and database sub-systems, such as cooperative or redundant processing and/or database servers that can be geographically dispersed throughout the network 200.

The PRM server 211 includes one or more databases 225 storing data relating to proprietary Risk management. The RMC server 210 and the PRM server 211 may interact with and/or gather data from an operator of a system access device 220-224 226 228 or other source. Data received may be structured according to Risk criteria and utilized to calculate a Risk quotient.

Typically an in-house user 222-224 or other user 220-221, 226, 228 will access the RMC server 210 using client software executed at a system access device 204-207, 212-214. The client software may include a generic hypertext markup language (HTML) browser, such as Netscape Navigator or Microsoft Internet Explorer, (a “WEB browser”). The client software may also be a proprietary browser, and/or other host access software.

In some cases, an executable program, such as a Java™ program, may be downloaded from the RMC server 210 to the network access device 204-207, 212-214 and executed at the system access device 204-207, 212-214 or computer, as part of the RMC Risk management software. Other implementations include proprietary software installed from a computer readable medium, such as a CD ROM. The invention may therefore be implemented in digital electronic circuitry, computer hardware, firmware, software, or in combinations of the above. Apparatus of the invention may be implemented in a computer program product tangibly embodied in a machine-readable storage device for execution by a programmable processor; and method steps of the invention may be performed by a programmable processor executing a program of instructions to perform functions of the invention by operating on input data and generating output.

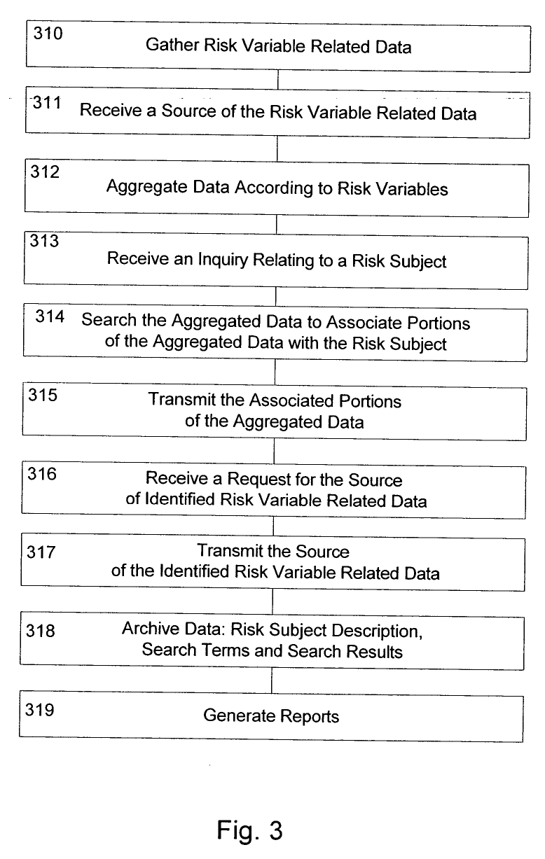

Referring now to FIG. 3, steps taken to manage Risks associated with a LTC can include gathering data relating to Risk entities and other Risk variables 310 and receiving 10 the gathered information into an RMC server 210. Informational data can be gathered from a source of electronic data such as, for example: an external database, a messaging system, a news feed, a government agency, any other automated data provider, an private investigation firm, a court reporter, a state regulator, an insurance company, a LTC facility, a LTC provider, a LTC recipient, a party associated with a LTC recipient, or other source. Information can be received on an ongoing basis such that if new events occur in the world that affect the Risk associated with a LTC facility or LTC provider, the calculated Risks can be adjusted accordingly.

A source of Risk variable data can also be received 311 by the RMC server 210 or other provider of Risk management related data. For example, a source of Risk variable data may include a government agency, an investigation firm, public records, news reports, publications issued by a commercial insurer, other government and non-government organizations, internet websites, news feeds, commercial databases, or other information sources.

The RMC server 210 can aggregate the data received according to LTC Risk variables 312 or according to any other data structure conducive to fielding LTC related Risk.

A RMC server 210 can be accessed in real time, or on a periodic basis. In real time embodiments, any changes to the RMC data 108 may be automatically forwarded to a subscriber 111 or an in-house PRM system 106. Embodiments utilizing periodic access, the RMC system 106 can be scheduled to receive queries at set intervals.

All data received can be combined and aggregated 312 to create an aggregate source of data which can be accessed to perform Risk management activities. Combining data can be accomplished by any known data manipulation method. For example, the data can be maintained in separate tables and linked with relational linkages, or the data can be gathered into on comprehensive table or other data structure. In addition, if desired, information received can be associated with one or more variables including a number of violations received during inspections and the type of violation; a quantity of complaints filed and the reason for such complaints; any fines levied against a LTC facility and/or provider; employment history of a key employee of a LTC provider; a record of conviction for any employee of an LTC provider; types of services offered by a LTC provider; cost of care at an LTC facility; financial statements relating to a LTC facility or LTC provider; any records relating to bankruptcy associated with an LTC provider, or other data.

The RMC server 210 or PRM server 211 can receive an inquiry relating to a Risk subject 313. The Risk subject can be any subject related to the variables discussed above, for example, a Risk subject can include a LTC facility, a LTC provider, the name of a LTC provider employee, or other related subject.

The inquiry from a subscriber 111, or other authorized entity, can cause the respective servers 210-211 to search the aggregated data 108 and associate related portions of aggregated data 108 with the Risk subject 314. The associated portions of aggregated data 108 can be transmitted 315 to a party designated by the requesting subscriber 111.

The RMC server 210 or PRM server 211 may also receive a request for a source of identified Risk variable related data 316, in which case, the RMC server 210 or PRM server 211 can transmit the source of the identified Risk variable related data to the requestor 317. The source may be useful in ascertaining the credibility of the Risk 5 variable related data, to follow up with a request for additional information or other purpose.

A RMC server 210 or PRM server 211 can also store in memory, or otherwise archive Risk management related data 108 and proceedings 318. Archived Risk management related data and proceedings can be useful to demonstrate historical perspective or quantify due diligence efforts relating to high Risk situations. Accordingly, reports quantifying risk subjects researched, Risk management procedures, executed due diligence, corporate governance or other matters can be generated 319.

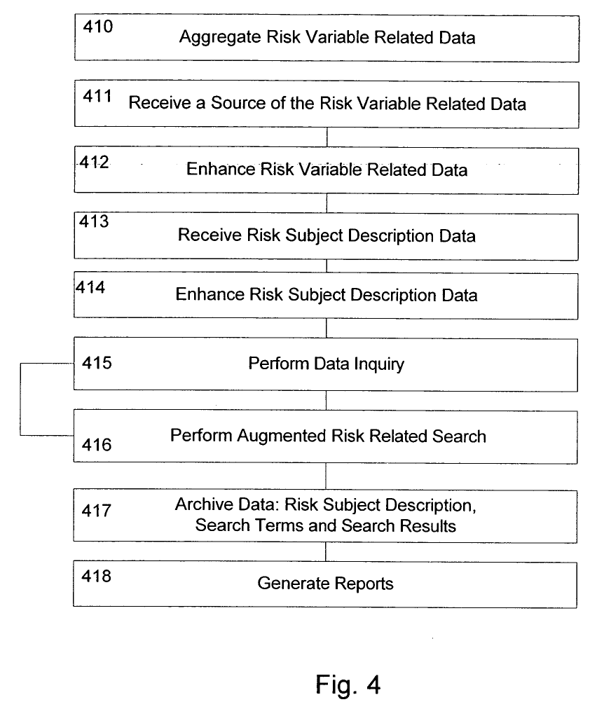

Referring now to FIG. 4, the present invention can also include steps that allow an RMC server 210 or PRM server 211 to provide data augmenting functionality that allows for more accurate processing of data related to Risk management. Accordingly, a RMC server 210 or PRM server 211 can aggregate Risk variable related data 410 and also the source of the Risk variable related data 411. The RMC server 210 or PRM server 211 can also enhance the Risk variable related data, such as through data scrubbing techniques or indexing as discussed above. A Risk subject description can also be received 413 and also scrubbed or otherwise enhanced 414.

An inquiry can be performed against the aggregated and enhanced data 415. In addition, an augmented search that incorporates data mining techniques 416 can also be included to further expand the depth of knowledge retrieved by the inquiry. If desired, a new inquiry can be formed as a result of the augmented search. This process can continue until the inquiry and augmentation ceases to add any additional meaningful value.

As discussed above, any searching and augmentation can be archived 417 and reports generated to quantify the due diligence efforts 418.

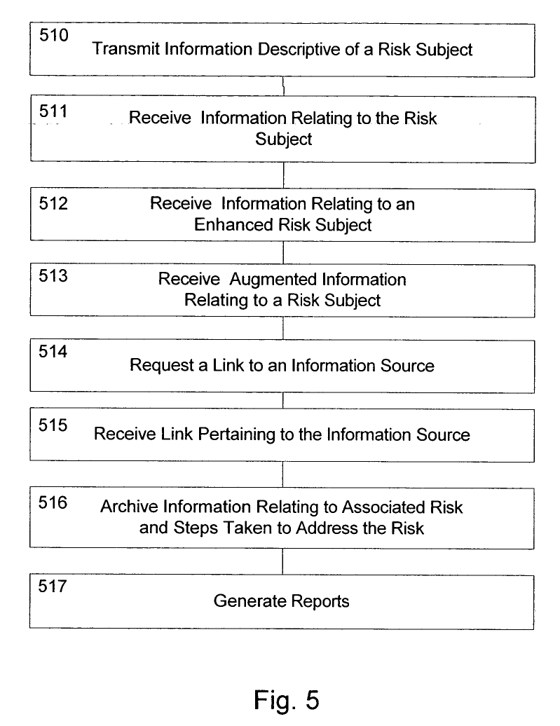

Referring now to FIG. 5, a flow chart illustrates steps that a user, such as a subscriber 111, can implement to manage Risk associated with a transaction. The user can receive information descriptive of a Risk subject, such as an entity associated with LTC 510. The user can access an RMC server 210 and identify to the RMC server 210 one or more Risk variables or search subjects related to LTC 511. Access can be accomplished by opening a dialogue with an RMC system 211 with a network access device, 204-207, 212-214. Typically, the dialogue would be opened by presenting a GUI to a network access device accessible by a person or an electronic feed that will enter information relating to the transactor. The GUI will be capable of accepting data input via a network access device. An example of a GUI would include a series of questions relating to a LTC variable. Alternatively, information can be received directly into fields of a database 108, such as from a commercial data source.

In some embodiments, automated monitoring software can run in the background of a normal transaction program and screen data traversing an application. The screened data can be processed to determine key words wherein the key words can in turn be presented to the RMC server 210 as Risk subjects or Risk variables. The RMC server 210 will process the key words to identify entities or other Risk variables. Monitoring software can also be installed to screen data traversing a network or communications link.

For example, monitoring software may be utilized in conjunction with an insurance provider or health care institution arranging for LTC for a patient. The monitoring software can screen data and automatically implement Risk searches related to the LTC.

The user will receive back information relating to Risk associated with the submitted subject 512. Embodiments can allow information to include enhanced data, such as scrubbed data. In some embodiments, a user can receive ongoing monitoring of key words, identified entities, a geographic location, or other subject, or list of subjects. Any updated information or change of status detected via an ongoing monitoring can result in an alarm or other alert being sent to one or more appropriate users. The user can also receive augmented information 513, such as data that has been processed through data mining techniques discussed above.

In addition to receiving augmented information 513, a user can also request an identifier, such as a link to a source of information 514. Receipt of a link pertaining to a source of information 515 may be useful to pursue more details relating to the information, or may be utilized to help determine the credibility of the information received.

A user can also cause an archive to be created relating to the Risk management 516. An archive may include, for example, information received relating to Risk associated with a LTC facility or provider, inquiries made and results of each inquiry. In addition, the user can cause an RMC server 210 to generate reports to quantify the archived information and otherwise document diligent actions taken relating to Risk management 517.

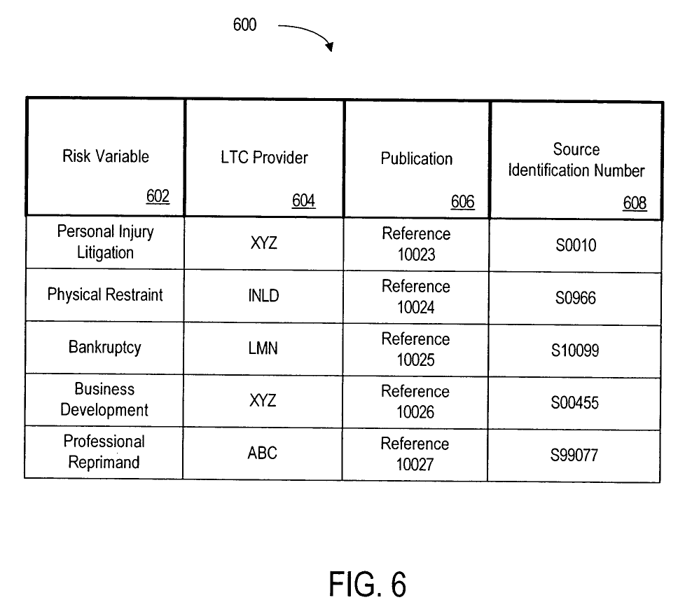

Referring now to FIG. 6, a portion of a data structure that can be utilized with some embodiments of the present invention is illustrated. The data structure 600 can include, for example, a data field for storing risk variables 602, a data field for storing a LTC provider 604, a data filed for storing a description of a publication or other document description 606, a data field for storing a description of an identification of a source of information 608, or other data fields. Data structures 600 can include relational data, hierarchical data, flat files or other formats known in the arts.

A number of embodiments of the present invention have been described. Nevertheless, it will be understood that various modifications may be made without departing from the spirit and scope of the invention. For example, a RMC server 210 can be made available on the Internet and receive input descriptive of a risk subject or be made available through a commercial information provider. In addition, a LTC related risk quotient can be compared to a cost associated with admittance to a LTC facility to provide a relative cost value. Accordingly, other embodiments are within the scope of the following claims.

What is claimed is:

1. A computer-implemented method for managing risk related to a long term care, the method comprising:
indicating in a computer system that an entity is a long term care entity according to the entity's status as at least one of: a long term care provider or a long term care facility operator;
gathering data into the computer system generally related to one or more long term care entities;
receiving data into the computer system descriptive of details of a long term care transaction wherein the data received comprises identification data for at least one long term care entity;
structuring the gathered data and the data relating details of the long term care transaction according to risk quotient criteria;
calculating a risk quotient by referencing the structured data; and
generating a report comprising the risk quotient and at least some of the structured data referenced to calculate the risk quotient.

2. The method of claim 1 wherein the long term care transaction comprises a financial investment in at least one of: a long term care facility and a long term care provider.

3. The method of claim 1 wherein the long term care transaction comprises a admittance to a long term care facility.

4. The method of claim 1 wherein the risk quotient comprises an indication of a cost to defend an adverse position.

5. The method of claim 1 wherein the risk quotient comprises an indication an amount of reputational risk.

6. The method of claim 1 wherein the risk quotient comprises an indication of an amount of regulatory risk.

7. The method of claim 1 wherein the risk quotient comprises an indication of an amount of legal risk.

8. The method of claim 1 wherein the risk quotient comprises an indication of an amount of risk associated with monetary costs related to potential fines.

9. The method of claim 1 wherein the gathered data comprises data descriptive of one or more world events which is received via a news feed.

10. The method of claim 1 wherein the gathered data comprises at least one government advisory.

11. The method of claim 1 wherein calculating the risk quotient criteria comprises a value determined by the steps of:
associating a numerical weight with each of a plurality of risk variables;
associating one or more of the risk variables with the data descriptive of details of a long term care transaction;
determining a numerical value based upon the content of the data descriptive of details of a long term care transaction associated with the one or more risk variables; and
multiplying the numerical value based upon the content times the numerical weight associated with each of the risk variables associated with the data descriptive of details of a long term care transaction.

12. The method of claim 1 additionally comprising the steps of presenting the report as evidence of due diligence to at least one of: a regulatory body, a shareholder and a news media.

13. The method of claim 1 additionally comprising the step of generating a suggested action based upon the risk quotient and at least some of the structured data referenced to calculate the risk quotient.

14. The method of claim 1 wherein the data gathered comprises data relating to a personnel employed by a long term care provider.

15. The method of claim 1 wherein the data gathered comprises data relating to patient welfare.

16. The method of claim 1 additionally comprising the steps of:
associating one or more statutes or regulations with the long term care transaction; and
transmitting a description of the associated statute with the data.

17. The method of claim 1 wherein transmitting the report is conditioned upon receipt of a contractual obligation not to use contents of the report for any purpose covered by the Fair Credit Reporting Act.

18. The method of claim 1 wherein the report comprises a record of conviction of an employee or owner of a long term care facility.

19. The method of claim 1 wherein the report comprises data descriptive of fines levied against a long term care facility or complaints filed against the facility.

20. The method of claim 1 wherein the report comprises one or more sources of the gathered data.

21. The method of claim 20 wherein the source comprises an investigation firm.

22. The method of claim 1 additionally comprising the step of transmitting an image of a document comprising data associated with the long term care transaction.

23. The method of claim 1 wherein report does not comprise any content created or developed by a provider of the system implementing the method for managing risk associated with long term care.

24. The method of claim 1 additionally comprises the steps of:
receiving a request for an alert;
monitoring the gathered data; and
transmitting a notification of new information received associated with the long term care risk subject.

25. The method of claim 1 wherein the data is gathered into a risk management clearinghouse.

26. The method of claim 1 wherein the data descriptive of details of a long term care transaction is received by a proprietary risk management system.

27. The method of claim 1 wherein at least one or: the gathered data and the data descriptive of details of a long term care transaction; comprise data provided by a long term care recipient.

28. The method of claim 1 additionally comprising the step of enhancing the gathered data.

29. The method of claim 28 wherein enhancing the data comprises scrubbing the data to incorporate changes in the spelling of words comprising the gathered data as compared to the data descriptive of details of a long term care transaction.

30. The method of claim 1 additionally comprising the step of augmenting at least one of: the gathered data and the data descriptive of details of a long term care transaction; via data mining.

31. The method of claim 1 wherein structuring the gathered data and the data relating details of the long term care transaction according to risk quotient criteria comprises processes based upon Boolean logic.

32. The method of claim 1 wherein structuring the gathered data and the data relating details of the long term care transaction according to risk quotient criteria comprises relevance ranking.

33. A computerized system for managing risk associated with long term care, the system comprising:
a computer server accessible with a system access device via a communications network; and
executable software stored on the server and executable on demand, the software operative with the server to cause the system to:
indicate in a computer system that an entity is a long term care entity according to the entity's status as at least one of: a long term care provider or a long term care facility operator;
gather data into the computer system generally related to one or more long term care entities;
receive data into the computer system descriptive of details of a long term care transaction wherein the data received comprises identification data for at least one long term care entity;
structure the gathered data and the data relating details of the long term care transaction according to risk quotient criteria;
calculate a risk quotient by referencing the structured data; and
generate a report comprising the risk quotient and at least some of the structured data referenced to calculate the risk quotient.

34. Computer executable program code residing on a computer-readable 30 medium, the program code comprising instructions for causing the computer to:
indicate in a computer system that an entity is a long term care entity according to the entity's status as at least one of: a long term care provider or a long term care facility operator;
gather data into the computer system generally related to one or more long term care entities;
receive data into the computer system descriptive of details of a long term care transaction wherein the data received comprises identification data for at least one long term care entity;
structure the gathered data and the data relating details of the long term care transaction according to risk quotient criteria;
calculate a risk quotient by referencing the structured data; and generate a report comprising the risk quotient and at least some of the structured data referenced to calculate the risk quotient.
